(19) United States
(12) Patent Application Publication
(10) Pub. No.: US 2012/0042041 A1
(43) Pub. Date: Feb. 16, 2012

(54) INFORMATION PROCESSING APPARATUS, INFORMATION PROCESSING SYSTEM, INFORMATION PROCESSING METHOD, AND PROGRAM

(75) Inventors: Ohji NAKAGAMI, Tokyo (JP); Masashi Uchida, Tokyo (JP)

(73) Assignee: Sony Corporation, Tokyo (JP)

(21) Appl. No.: 13/197,819

(22) Filed: Aug. 4, 2011

(30) Foreign Application Priority Data
Aug. 11, 2010 (JP) 2010-180315

(51) Int. Cl. G06F 15/173; G06F 15/16

(52) U.S. Cl. 709/217; 709/224

(57) ABSTRACT

An information processing method includes collecting interest information indicating a plurality of responses to a content. The information processing method also includes analyzing the interest information to produce a plurality of groups and generating a plurality of digests of the content for the plurality of groups.

### BACKGROUND

The present disclosure relates to an information processing apparatus, an information processing system, an information processing method, and a program.

In recent years, since various kinds of content such as news, movies, dramas, and music have been released on the Internet, users increasingly have a chance to view the content. When the users view content such as videos, the users sometimes download and watch content which the users are interested in or reproduce the content in a streaming manner after viewing a digest (summarization). For example, according to the technique disclosed in Japanese Patent No. 3803311, the emphasis state probability and the tranquil state probability are calculated using a fundamental frequency, power, a temporal variation feature of a dynamic feature, or an inter-frame difference thereof, an emphasis state is determined based on the probabilities, and digest content is summarized at an arbitrary length.

An example of the related art is Japanese Unexamined Patent Application Publication No. 2008-244746.

Another example of the related art is Japanese Unexamined Patent Application Publication No. 2010-28585.

### SUMMARY

However, when a digest is generated in accordance with the techniques disclosed in the related art, processing is mechanically performed irrespective of the details of the content. Therefore, the generated digest is just a general digest and is not a digest matching with the preference of individual viewers.

For example, an example of an optimized digest is a movie trailer. Since the movie trailer serves to increase an advertising effect for a movie, the plurality of movie trailers with different patterns is generally generated for one movie in response to the taste or the like of viewers. This is possible for the first time by analyzing the preference of viewers and take meaningful content of each scene into consideration. In the methods disclosed in the techniques according to the related art, it is difficult to generate a digest optimized for an individual viewer.

It is desirable to provide an information processing apparatus, an information processing system, an information processing method, and a medium including a program which are novel and improved and are capable of generating digests from arbitrary content in response to the preferences of users.

The information processing method can include collecting interest information indicating a plurality of responses to a content, analyzing the interest information to produce a plurality of groups, and generating a plurality of digests of the content for the plurality of groups.

The interest information can be temporal or spatial area information in the content, and the digest can include video and sound data summarized from the content.

The analyzing can be performed by clustering the temporal or spatial area information to obtain the plurality of groups.

The information processing method can include analyzing profile information of each of the plurality of responses of one of the plurality of groups to acquire a feature of the one of the plurality of groups, acquiring profile information from a client, and comparing the profile information from the client with the feature of the one of the plurality of groups.

The information processing method can include transmitting one of the plurality of digests for the one of the plurality of groups to the client.

The information processing method can include determining which one of the plurality of groups has profile information closest to the profile information from the client, and transmitting to the client the one of the plurality of digests for the one of the plurality of groups having the profile information closest to the profile information from the client. The analyzing the profile information can include analyzing profile information of each of the plurality of responses of each of the plurality of groups to acquire a respective feature of each of the plurality of groups. The comparing can include comparing the profile information from the client with the respective feature of each of the plurality of groups.

The feature can include at least one of an age and a gender.

The feature can indicate a viewing history.

The feature can include an interest.

The information processing method can include acquiring metadata of the content, and determining a predetermined number of the plurality of groups based on the metadata.

The information processing method can include transmitting the plurality of digests to a client.

The information processing method can include receiving a content request from the client, and transmitting the content in response to the content request.

The information processing method can include receiving interest information from the client after the transmitting the content, analyzing the interest information received from the client, and generating a digest of the content based on the interest information received from the client, by a clustering.

The digest can be video data.

Each of the plurality of digests can be for a respective group of the plurality of groups. One of the plurality of digests can be generated for a specific sports team.

One of the plurality of digests can be generated for a specific sports player.

One of the plurality of digests can be generated for a specific singer.

In another embodiment, a computer-readable storage medium can be encoded with computer executable instructions, wherein the instructions, when executed by a processing unit, cause the processing unit to perform a method including collecting interest information indicating a plurality of responses to a content, analyzing the interest information to produce a plurality of groups, and generating a plurality of digests of the content for the plurality of groups. In yet another embodiment, an information-processing apparatus includes an interest information acquisition unit that collects interest information indicating a plurality of responses to a content. The information-processing apparatus also includes an interest information analysis unit configured to analyze the interest information to produce a plurality of groups. In addition, the information-processing apparatus includes a digest generation unit configured to generate a plurality of digests of the content for the plurality of groups.

According to the embodiments of the disclosure, it is possible to generate the digests from arbitrary content in response to the preferences of the users.

### BRIEF DESCRIPTION OF THE DRAWINGS

FIG. 1 is a schematic diagram illustrating the configuration of a system according to an embodiment of the disclosure.

FIG. 2 is a schematic diagram illustrating a process of analyzing interest information in an interest information analysis unit.

FIG. 3A is a schematic diagram illustrating a case where three digests are displayed in a display unit of a client terminal and only one digest selected by a user or the system is exclusively displayed.

FIG. 3B is a schematic diagram illustrating a case where the three digests A, B, and C are simultaneously reproduced spatially and temporally in the display unit of the client terminal.

FIG. 4 is a flowchart illustrating processing according to the embodiment.

FIG. 5 is a diagram illustrating a sequence of the processing of the system according to the embodiment.

FIG. 6 is a flowchart illustrating generating a digest.

### DETAILED DESCRIPTION OF EMBODIMENTS

Hereinafter, a preferred embodiment of the disclosure will be described in detail with reference to the accompanying drawings. The same reference numerals are given to constituent elements having the same actual function throughout the specification and the drawings and the description thereof will not be repeated.

The description will be made in the following order.

1. Exemplary Configuration of System

2. Process of Analyzing Interest Information

3. Process of Transmitting One Optimum Digest to Specific User

4. Processing of System according to Embodiment

### 1. Exemplary Configuration of System

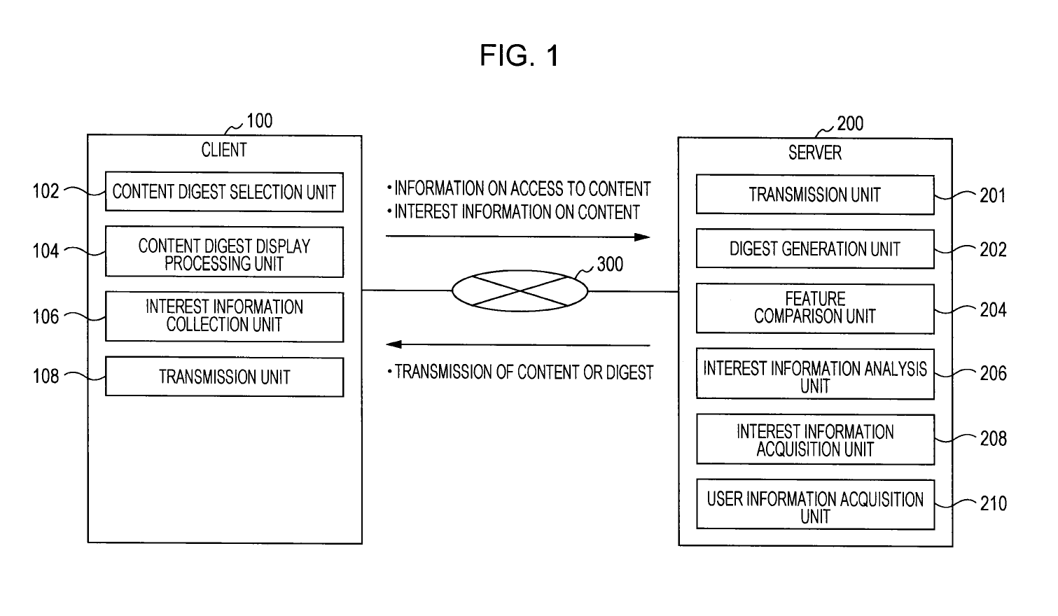

Hereinafter, an embodiment of the disclosure will be described with reference to the drawings. FIG. 1 is a schematic diagram illustrating the configuration of a system according to this embodiment. As shown in FIG. 1, the system includes a client terminal 100 and a server 200. The client terminal 100 and the server 200 are connected to each other via a communication line network such as the Internet 300.

For example, the client terminal 100 is an apparatus such as personal computer (PC) and can receive a content item or a digest from the server 200 via the Internet 300 in accordance with a streaming or download method. For example, the content includes video and sound data which a user watches. The digest includes video and sound data summarized from one content item.

As shown in FIG. 1, the client terminal 100 includes a content digest selection unit 102, a content digest display processing unit 104, an interest information collection unit 106, and a transmission unit 108. The content digest selection unit 102 selects a content item or a digest transmitted from the server 200 based on information input through an input unit (not shown) such as a mouse or a keyboard by the user. Such an input unit, mouse, or keyboard can be a means for inputting. The content digest display processing unit 104 displays the content item or the digest selected by the user. The interest information collection unit 106 acquires the response of the user when the user watches the content and collects interest information based on the response of the user. The transmission unit 108 transmits the interest information collected by the interest information collection unit 106 to the server 200. Moreover, the transmission unit 108 also has a function of transmitting user information (e.g., profile information) described below to the server 200 and a function of transmitting request information to the server 200 when the user makes a request for a content item. Thus, the transmission unit 108 can be, for example, a network device. That is, a network device can be a means for transmitting. The client terminal 100 also includes a display unit (not shown), such as a liquid crystal display, for displaying a content item or a digest. Such a display unit or liquid crystal display can be a means for displaying.

The server 200 has a function of transmitting content to the client terminal 100 and a function of generating a digest of the content and transmitting the digest to the client terminal 100. As shown in FIG. 1, the server 200 includes a transmission unit 201, a digest generation unit 202, a feature comparison unit 204, an interest information analysis unit 206, an interest information acquisition unit 208, and a user information acquisition unit 210. The server 200 includes a database (not shown in FIG. 1) for storing a plurality of content items.

The transmission unit 201 transmits the content or the digest to the client terminal 100. The digest generation unit 202 generates a digest of the content. The interest information acquisition unit 208 acquires the interest information transmitted from the client terminal 100. The interest information analysis unit 206 analyzes the interest information transmitted from the client terminal 100. For example, the interest information analysis unit 206 analyzes the interest information in accordance with a method such as clustering described below. The feature comparison unit 204 compares the user information (profile information) transmitted from the client terminal 100 to the analysis result of the interest information, based on a feature. The digest generation unit 202 generates a digest based on the analysis result of the interest information analyzed by the interest information comparison unit 206 or the comparison result obtained through the comparison of the feature comparison unit 204. The generated digest is transmitted to the client terminal 100. The user information acquisition unit 210 acquires the user information transmitted from the client terminal 100. The transmission unit 201, the interest information acquisition unit 208, and the user information acquisition unit 210 can be a network device. Indeed, a single network device can perform the operations of those three units. Such a network device can be a means for transmitting or for receiving data.

The respective constituent units of the client terminal 100 and the server 200 shown in FIG. 1 can be configured by hardware (circuit), or a central processing unit (CPU) and software (program) executed thereby. Such hardware, circuit, and CPU can be a means for performing the functions of the various units. In this case, the program can be stored in non-transitory media, such as a memory of the client terminal 100 or the server 200, a recording medium such as a hard disk, or an external recording medium mounted from the outside. The program can also be stored in transitory media, such as a wave.

### 2. Process of Analyzing Interest Information

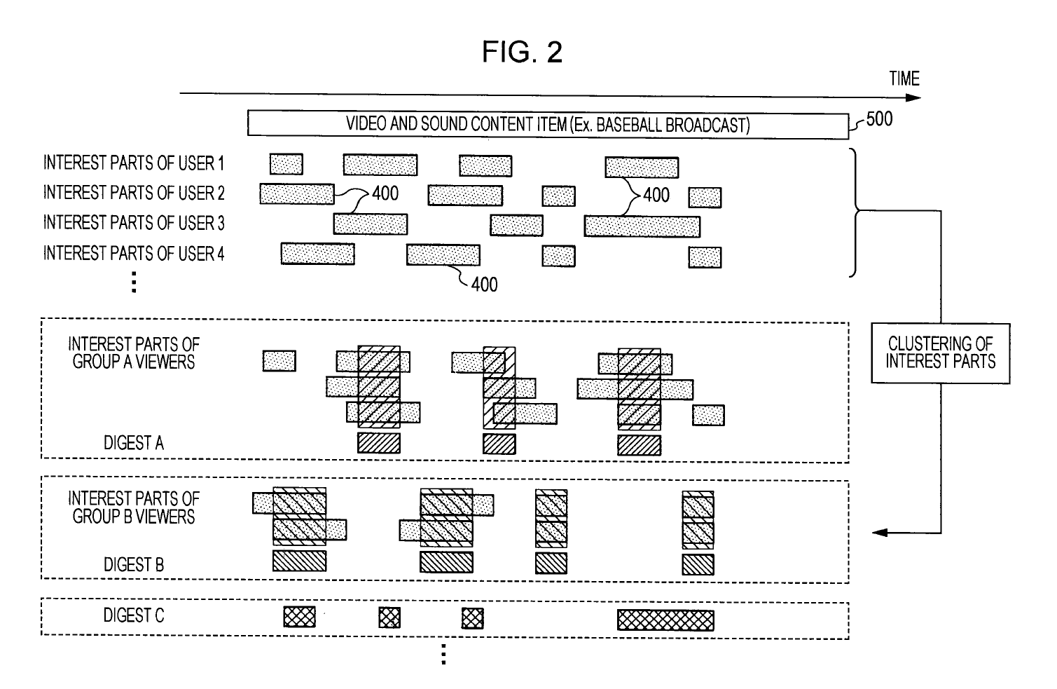

FIG. 2 is a schematic diagram illustrating a process of analyzing the interest information in the interest information analysis unit 206. The interest information acquisition unit 208 acquires the interest information indicating the response of a viewer to content. Specifically, the interest information is temporal or spatial area information in the content which a user is interested in or sympathetic to. The interest information may be positive or negative information.

As described above, the interest information is collected by the interest information collection unit 106 of the client terminal 100 and is transmitted to the server 200. The interest information can be acquired in accordance with a technique according to the related art. For example, a viewer can explicitly input the interest information to the client terminal 100 using an interface such as a keyboard or a mouse, while the viewer is watching the content. Moreover, the client terminal 100 may automatically acquire the interest information by observing information regarding the viewer using a camera or a bio-monitor connected to the client terminal 100.

The interest information obtained in this manner from a plurality of viewers is input to an interest information analysis unit 206 of the server 200. The interest information analysis unit 206 performs clustering on the input interest information and outputs the result obtained through the clustering. In the upper part of FIG. 2, a plurality of viewers (users 1, 2, 3, 4, and so on) feedback temporal interest information regarding one content item 500. In the example shown in FIG. 2, interest parts 400 of the users 1, 2, 3, 4, and so on are input as the interest information. The horizontal axis in FIG. 2 represents a time. The interest parts of the users 1, 2, 3, 4, and so on indicate interest parts (a period of time) which the users are interested in among the entire content item 500.

In the lower part of FIG. 2, the results are shown which are obtained by performing the clustering on the interest parts of the users 1, 2, 3, 4, and so on. The interest information analysis unit 206 analyzes the interest parts of the respective users. In the example shown in FIG. 2, the interest parts which the users are interested in among the entire content item 500 are broadly classified into two groups by clustering the interest parts of the respective users. The interest parts of the viewers belonging to Group A in FIG. 2 correspond to interest parts which, for example, the users 1 and 3 are interested in. Moreover, the interest parts of the viewers belonging to Group B correspond to interest parts which, for example, the users 2 and 4 are interested in.

In FIG. 2, all of the viewers are not interested in the same periods of time within the entire content item 500, and a plurality of viewers is interested in different parts (periods of time). The clustering itself can be realized in accordance with the technique according to the related art, and the clustering method is not particularly limited. Groups of viewers interested in a specific time in the content item 500 can be obtained through the clustering. As shown in FIG. 2, on the assumption that these groups are Group A, Group B, and so on, the interest parts which the viewers belonging to Group A are interested in and the interest parts which the viewers belonging to Group B are interested in are different from each other. It can be assumed that the number of groups may be two or more.

For example, when the content item 500 is a baseball program, the interest information is increased for the period of time in which a team supported by a user attacks and the interest information is decreased for the period of time in which the team supported by the user blocks the attack. In this case, as shown in FIG. 2, it is assumed that the interest parts can be divided into Group A and Group B depending on the user's preference of supporting either team.

In this embodiment, when the interest of the viewers is divided into a plurality of tendencies in accordance with the clustering result, the plurality of digests is generated in response to the tendencies. As shown in FIG. 2, a digest A is generated in accordance with the interest parts of the viewers belonging to Group A, and a digest B is generated in accordance with the interest parts of the viewers belonging to Group B.

Thus, the digest A indicating the preference of the viewers belonging to Group A can be generated using the interest parts of Group A. Likewise, the digest B indicating the preference of the viewers belonging to Group B can be generated using the interest parts of Group B. The same can be applied to a digest C.

As described above, the clustering is performed by the interest information analysis unit 206 of the server 200. The digest generation unit 202 can generate the plurality of digests in accordance with the preferences (interests) of the plurality of users based on the clustering results shown in FIG. 2.

The transmission unit 201 of the server 200 transmits the digests generated by the digest generation unit 202 to the client terminal 100. At this time, the transmission unit 201 can transmit the plurality of digests A, B, C, and so on to the client terminal 100. When one digest is specified through the processing of the feature comparison unit 204, as described below, the specified digest is transmitted to the client terminal 100.

The content digest selection unit 102 of the client terminal 100 selects a digest in response to an input of the user. The content digest display unit 104 displays the selected digest.

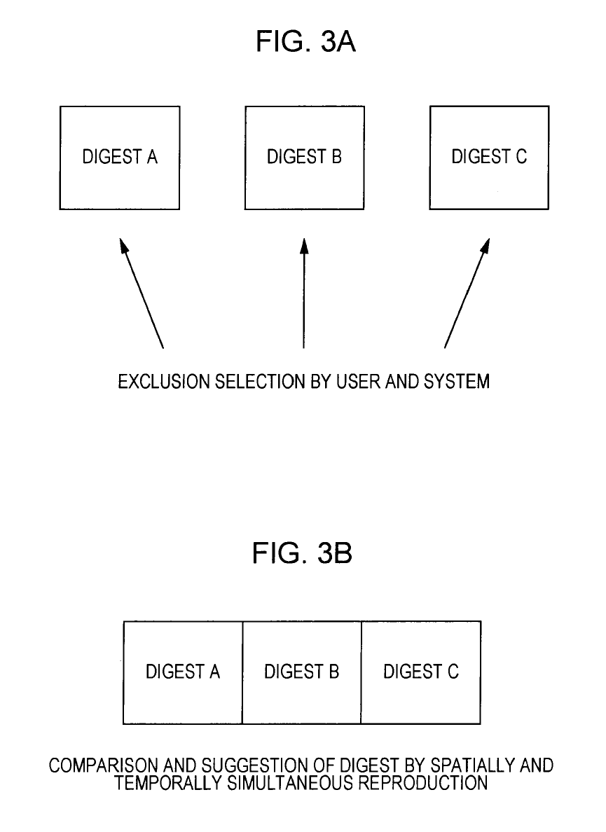

FIGS. 3A and 3B are schematic diagrams illustrating a case where the digests A, B, and C are selected by the client terminal 100 when the plurality of digests A, B, and C is transmitted to the client terminal 100. Here, in FIG. 3A, three digests are displayed on the display unit of the client terminal 100 and only one digest selected by the user or the system is exclusively displayed. In this case, only the selected digest is reproduced, whereas the other digests are not reproduced. The selection of the digest can be performed, for example, when the user clicks any one of the digests.

In FIG. 3B, the three digests A, B, and C are simultaneously reproduced spatially and temporally on the display unit of the client terminal 100. In this case, the other digests can simultaneously be viewed in one content item 500. Moreover, when the user clicks one digest, only the clicked digest can be enlarged and displayed.

Thus, for example, when the user 1 selects the digest A, the user 1 can watch only the video of the period of time which the user 1 is interested in. Likewise, when the user 2 selects the digest B, the user 2 can watch only the video of the period of time which the user 2 is interested in. Accordingly, when each user watches the digest in accordance with that user's taste, each user can watch only the video which the user is interested in. Moreover, when each user watches the digest and then desires to watch the entire content, that user operates a mouse, a keyboard, or the like to transmit information regarding a content request from the transmission unit 108 to the server 200. The transmission unit 201 of the server 200 transmits the content to the client terminal 200 in accordance with the information regarding the content request. When the content digest selection unit 102 of the client terminal 100 selects the content, the content digest display processing unit 104 performs display processing to display the content on the display unit.

Thus, the digests used to display and reproduce the different viewpoints of other users can be generated through the clustering of the interest information analysis unit 206. When the result obtained through the clustering of the interest information analysis unit 206 of the server 200 is supplied to the client terminal 100 as it is, the user can select the digests of the plurality of viewpoints. Thus, the clustering result of the interest information reflects the preference of the viewers having the same tendency. Accordingly, it can be said that the digests of the other groups reflect different viewpoints.

In the application of the content item 500 of the baseball program, as in the above-described example, the digests can be generated by the number of scoring scenes of one team in Group A, and the digests can be generated by the number of scoring scenes of the other team in Group B. Accordingly, the digests are generated for each of the clustered groups and the user can compare the digests of the plurality of viewpoints from one content item to each other by allowing the client terminal 100 to simultaneously display and reproduce the digests.

When the groups are classified, metadata of a program may be used. For example, when the content is a baseball program, as described above, it is supposed that the groups are broadly classified into two groups. Therefore, information indicating that the content is the “baseball program” from the metadata may be acquired, and the groups may be classified into two groups based on this information. Likewise, for example, when the content is a political discussion program, it is supposed that the interests of users are classified into the number of groups corresponding to the number of discussers (or the number of political parties). Therefore, the number of groups may be acquired in advance from the metadata and the clustering may be performed. A more precise classification can be realized by classifying the groups of the interests of the users together with the metadata of the content.

According to this embodiment, all of the digests may not be mechanically processed, but can be generated based on feedback information such as the interest information regarding a content item from a single user or a plurality of users. In this method, users can be clustered into several groups with a similar taste. It is possible to generate the digest optimum for each group by using the interest information feedback from each group in the reproduced content.

Moreover, it is possible to obtain the digests of the plurality of viewpoints from one content item by clustering the users and generating the digests from the tastes of the plurality of groups. Thus, for example, in a discussion program or a sports game, positive parts and negative parts can be generated in a theme of the content including a plurality of opinions.

Such interest information can be acquired explicitly from the user by using the interface such as a mouse while the user is watching the content or after the user watches the content or by measuring the psychological states of the viewers using a camera, a bio-monitor, or the like.

For example, in a baseball program, digests for the fans of a specific team or digests for the fans of a specific player can be generated as well as interesting parts such as scoring scenes, as in the related art.

For example, in a discussion program, it is possible to generate digests which can be watched while positive opinion parts of a political ruling party and opposite opinion parts of a political opposition party are compared to each other. For another example, in a plurality of music programs, digests for the fans of a specific singer can also be generated.

### 3. Process of Transmitting One Optimum Digest to Specific User

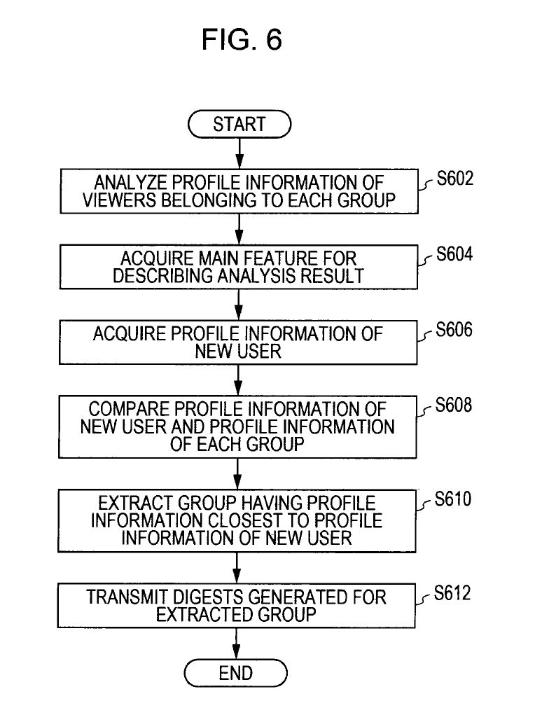

Next, a method of generating and displaying one optimum digest for a viewer X who does not watch the content item 500 will be described with reference to FIG. 6. Therefore, in step S602, the server 200 analyzes profile information (user information) of the viewers belonging to each of the clustered groups. The profile information includes information regarding the content along with age or sex, past viewing history, or interest. The main feature for describing the clustering result is acquired from the interest information regarding the content based on the profile information in step S604. The feature sometimes includes a plurality of items.

Next, in step S606, the server 200 acquires the profile information regarding the user X. The feature comparison unit 204 compares the profile information regarding the user X to the profile information of each of the clustered groups in step S608 and extracts in step S610 the group having profile information which is the closest to the profile information regarding the user X. Then, in step S612, the digests generated for the extracted group are transmitted to the client terminal 100. According to this method, the digest generated by extracting only the interest part of the user X can be transmitted to the client terminal 100 of the user X.

4. Processing of System according to Embodiment

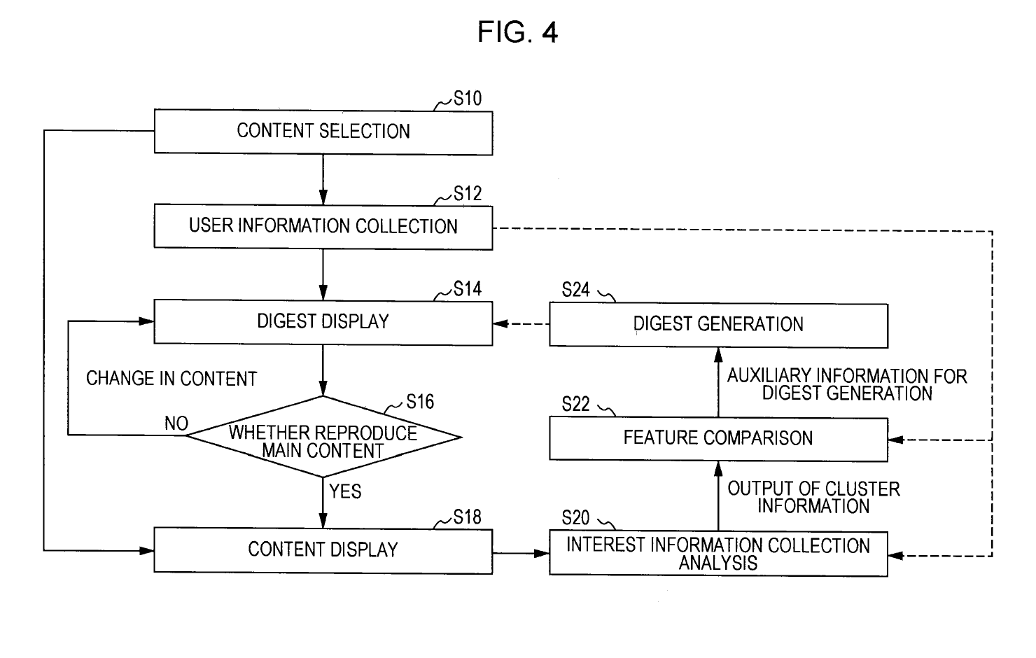

Next, the processing of the system according to this embodiment will be described. FIG. 4 is a flowchart illustrating processing according to the embodiment. In the flowchart of FIG. 4, the processing of the client terminal 100 and the processing of the server 200 are shown on the left and right sides, respectively. In FIG. 4, a process of transmitting only one digest optimum for the user by the processing of the feature comparison unit 204 is shown. First, in step S10, the content is selected in the client terminal 100 and the user watches an arbitrary content item 500. Next, in step S12, the interest information is collected in the client terminal when the user watches the arbitrary content item 500.

On the other hand, the interest information and profile information of the user is collected in the server 200 in step S20, the interest information is analyzed, and the clustering is performed, as described with reference to FIG. 2. Next, in step S22, the feature comparison unit 204 compares features of the profile information of the user and of the profile information of each group to one another. Next, in step S24, the optimum digest is generated based on the comparison result of the features.

The digest generated in step S24 is transmitted to the client terminal 100 and is displayed in step S14. Next, in step S16, the user watching the digest inputs, to the client terminal 100, whether to reproduce the original content (the entire content). When the original content is reproduced, the process proceeds to step S18 to display the entirety of the original content. On the other hand, when the original content is not reproduced in step S16, the process returns to step S14 and the content is changed by watching another digest. Also, in step S10, when the user selects reproduction of the original content, the process proceeds to step S18 to reproduce the original content.

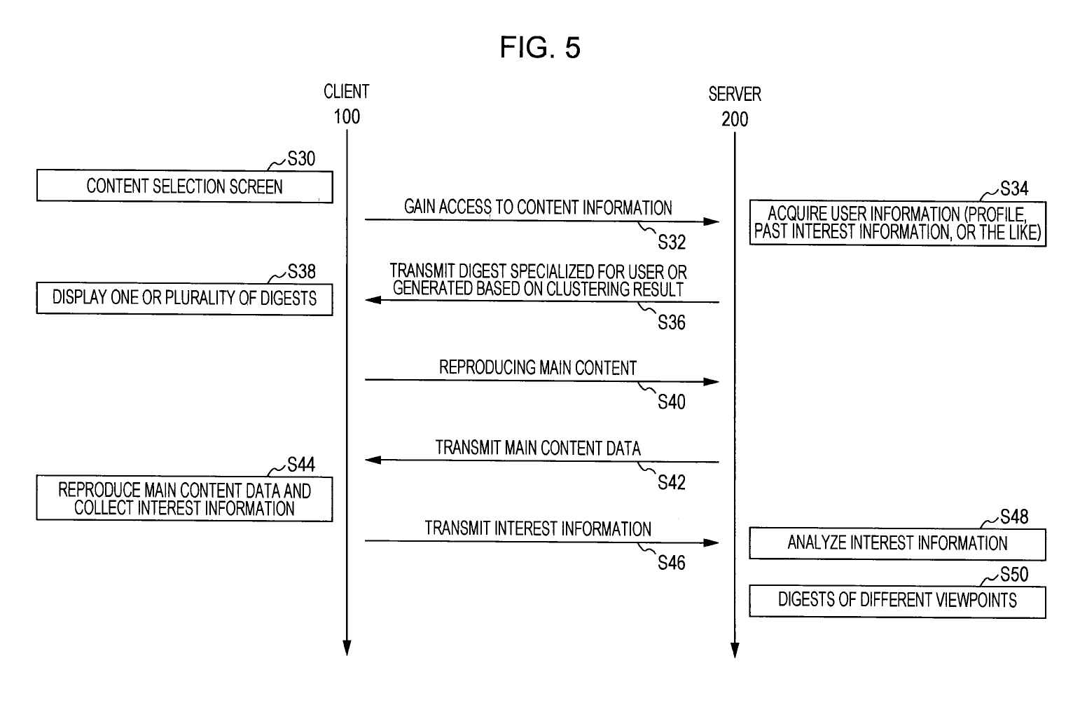

FIG. 5 is a diagram illustrating a sequence of the processing of the system according to the embodiment. First, in step S30, a screen is displayed on the client terminal 100 to select the content. When the user selects an arbitrary content, an access to content information of the server 200 is gained (step S32) after the profile information regarding the user is transmitted to the server 200. The server 200 acquires the profile information regarding the user (step S34) and compares the profile information of each of the clustered groups in the content selected by the user to the profile information regarding the user. The digest tailored for the user is transmitted to the client terminal 100 as the comparison result (step S36). When the feature comparison unit 204 does not compare the features to each other, the plurality of digests generated in response to the clustering result is transmitted to the client terminal 100.

Next, in step S38, the client terminal 100 displays the digests transmitted from the server 200. At this time, when the digest transmitted from the server 200 is one digest obtained by comparing pieces of the profile information, only one digest is displayed. When the plurality of digests is transmitted from the server 200, the plurality of digests is displayed.

Next, when a request for reproducing the original content is given from the client terminal 200 in which the digest is watched (step S40), the server 200 transmits the data of the original content to the client terminal 100 (step S42).

The client terminal 100 collects the interest information using the interest information collection unit 106 in step S44 while the user watches the original content. Then, in step S46, the client terminal 100 transmits the interest information to the server 200 using the transmission unit 108. The server 200 analyzes the interest information (step S48) using the interest information analysis unit 206 and generates the digests of different viewpoints through the clustering (step S50) using the digest generation unit 202.

According to this embodiment, as described above, the digest optimum in accordance with the viewer group can be generated without direct analysis of the meaningful details of the content item 500 by collecting and analyzing the responses of the viewers to the content item 500. Accordingly, each viewer can watch only a video which the user is interested in by selecting a desired digest.

The present disclosure contains subject matter related to that disclosed in Japanese Priority Patent Application JP 2010-180315 filed in the Japan Patent Office on Aug. 11, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing method, comprising:
collecting interest information indicating a plurality of responses to a content;
analyzing the interest information to produce a plurality of groups; and
generating a plurality of digests of the content for the plurality of groups.

2. The information processing method according to claim 1, wherein the interest information is temporal or spatial area information in the content, and the digest includes video and sound data summarized from the content.

3. The information processing method according to claim 2, wherein the analyzing is performed by clustering the temporal or spatial area information to obtain the plurality of groups.

4. The information processing method according to claim 1, further comprising:
analyzing profile information of each of the plurality of responses of one of the plurality of groups to acquire a feature of the one of the plurality of groups;
acquiring profile information from a client; and
comparing the profile information from the client with the feature of the one of the plurality of groups.

5. The information processing method according to claim 4, further comprising:
transmitting one of the plurality of digests for the one of the plurality of groups to the client.

6. The information processing method according to claim 4, further comprising:
determining which one of the plurality of groups has profile information closest to the profile information from the client; and
transmitting to the client the one of the plurality of digests for the one of the plurality of groups having the profile information closest to the profile information from the client, wherein the analyzing the profile information includes analyzing profile information of each of the plurality of responses of each of the plurality of groups to acquire a respective feature of each of the plurality of groups, and the comparing includes comparing the profile information from the client with the respective feature of each of the plurality of groups.

7. The information processing method according to claim 4, wherein the feature includes at least one of an age and a gender.

8. The information processing method according to claim 4, wherein the feature indicates a viewing history.

9. The information processing method according to claim 4, wherein the feature includes an interest.

10. The information processing method according to claim 1, further comprising:
acquiring metadata of the content; and
determining a predetermined number of the plurality of groups based on the metadata.

11. The information processing method according to claim 1, further comprising:
transmitting the plurality of digests to a client.

12. The information processing method according to claim 11, further comprising:
receiving a content request from the client; and
transmitting the content in response to the content request.

13. The information processing method according to claim 12, further comprising:
receiving interest information from the client after the transmitting the content;
analyzing the interest information received from the client; and
generating a digest of the content based on the interest information received from the client, by a clustering.

14. The information processing method according to claim 1, wherein the digest is video data.

15. The information processing method according to claim 1, wherein each of the plurality of digests is for a respective group of the plurality of groups.

16. The information processing method according to claim 1, wherein one of the plurality of digests is generated for a specific sports team.

17. The information processing method according to claim 1, wherein one of the plurality of digests is generated for a specific sports player.

18. The information processing method according to claim 1, wherein one of the plurality of digests is generated for a specific singer.

19. A computer-readable storage medium encoded with computer executable instructions, wherein the instructions, when executed by a processing unit, cause the processing unit to perform a method comprising:
collecting interest information indicating a plurality of responses to a content;
analyzing the interest information to produce a plurality of groups; and
generating a plurality of digests of the content for the plurality of groups.

20. An information-processing apparatus, comprising:
an interest information acquisition unit that collects interest information indicating a plurality of responses to a content;
an interest information analysis unit configured to analyze the interest information to produce a plurality of groups; and
a digest generation unit configured to generate a plurality of digests of the content for the plurality of groups.
